(19) United States
(12) Patent Application Publication
(10) Pub. No.: US 2008/0040437 A1
(43) Pub. Date: Feb. 14, 2008

(54) Mobile Social Networking Platform

(76) Inventors: Mayank Agarwal, Ashland, MA (US); Patrick J. Cody, Wilmington, MA (US); Antti Hietala, Charlestown, MA (US)

Correspondence Address: McGUINNESS & MANARAS LLP, 125 NAGOG PARK, ACTON, MA, 01720, US

(21) Appl. No.: 11/833,364

(22) Filed: Aug. 3, 2007

Related U.S. Application Data
(60) Provisional application No. 60/821,998, filed on Aug. 10, 2006.

(51) Int. Cl. G06F 15/16

(52) U.S. Cl. 709/206

(57) ABSTRACT

A mobile social networking platform integrates SMS (text messaging) services with Instant Messaging services so that cross-platform messages can be sent, e.g., text-to-IM and IM-to-text. In response to a text message sent by a user, an integration server prompts a corresponding IM message to be sent to the recipient. In one embodiment the integration server prompts transmission of the IM by logging into the user's IM account or accounts. An instant message corresponding to the text message is then sent to the recipient designated by the user via the user's IM account. After prompting transmission of the instant messages by the associated service, the integration server logs-off from the user's IM account or accounts. In an alternative embodiment the integration server itself generates the IM. In order to send an IM to text message a user logs onto an IM client, selects the integration server from a buddy list, composes the message for a particular group, then sends the message to the integration server. The integration server receives message and, based on the message content and the sender, the integration server identifies at least one of the user's ‘groups’ to which the message is to be sent. The group may comprise all subscribers of a group via IM, text and/or email. If a designated recipient is logged-in to the integration server via mobile phone, a corresponding text message is delivered to that mobile phone.

### CROSS-REFERENCE TO RELATED APPLICATIONS

A claim of priority is made to U.S. Provisional Patent Application 60/821,998, entitled MOBILE NETWORKING PLATFORM, filed Aug. 10, 2006, which is incorporated by reference.

### FIELD OF THE INVENTION

This invention is generally related to the field of mobile communications, and more particularly to a mobile social networking platform that integrates different communication services.

### BACKGROUND OF THE INVENTION

Non-voice electronic communications technologies are now widely used by enterprises and individual subscribers. Examples of such technologies include email, instant messaging and text messaging. Instant messaging (IM) and short message service (SMS) text messaging enjoy particular popularity among younger subscribers. Each of these technologies has certain advantages and disadvantages. Email, for example, is particularly well suited for communications between more than two persons which do not need to be conducted in real time. Instant messaging is somewhat similar to email, but differs in that conversations happen in real-time. Text messaging is particularly well suited to use with mobile phones, but can be costly.

Each of the non-voice technologies require that a client connect with a service in order to transmit and receive communications. A multiprotocol instant messaging application allows one client to connect to multiple IM networks. Generally, however, services from a given provider are incompatible with services from other providers.

### SUMMARY OF THE INVENTION

In accordance with one embodiment of the invention, a method of providing a message comprises the steps of: receiving a message from a user via a first communication service; identifying at least one intended recipient of the message; logging into or having immediate access to a second communication service with user-provided information; and prompting transmission of the message to at least one intended recipient via the second communication service.

In accordance with another embodiment of the invention, a computer readable medium encoded with program code for providing a message comprises: logic for receiving a message from a user via a first communication service; logic for identifying at least one intended recipient of the message; logic for logging into or having immediate access to a second communication service with user-provided information; and logic for prompting transmission of the message to at least one intended recipient via the second communication service.

In accordance with another embodiment of the invention, apparatus for providing a message comprises: a network device in communication with a network, and including a receiver operable to receive a message from a user via a first communication service; a processor operable to identifying at least one intended recipient of the message; and a transmitter operable to login to or having immediate access to a second communication service with user-provided information and prompting transmission of the message to at least one intended recipient via the second communication service.

At least some embodiments of the invention can provide a mobile social networking platform that advantageously integrates different types of service, and different services of a given type, transparently and without requiring cooperation of all users. This advantage is enabled by utilizing the sender's own service accounts to prompt delivery of messages to the recipients. From the perspective of the user-recipient, a message will appear to have been sent via a standard instant message. Hence, the user-recipient is not required to log in to the integration device. Further, the invention can be utilized to favor use of particular services over others based on cost and other factors. For example, a sender may mitigate text message costs by sending a text message to a single group address which is utilized by the integration device to generate multiple instant messages. Other features and advantages of the invention will become apparent in view of the Detailed Description and Figures.

### BRIEF DESCRIPTION OF THE FIGURES

FIG. 1 illustrates a mobile social networking platform.

FIG. 2 is a flow diagram illustrating how a user joins the mobile social networking platform.

FIGS. 3 and 4 are flow diagrams illustrating operation of the mobile social networking platform.

### DETAILED DESCRIPTION

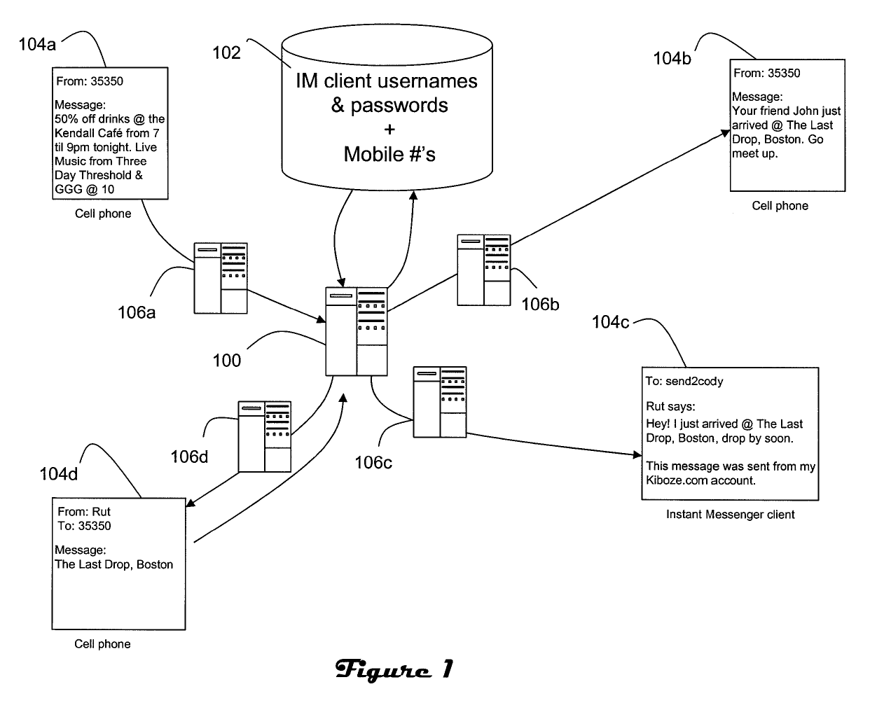

Referring to FIG. 1, a mobile social networking platform includes an integration server (100) and an associated database (102). The integration server is connected with one or more networks, such as the Internet, via which communications can be transmitted and received. In particular, the integration server can communicate with terminal devices (104a-104d) via SMS text and Instant Messaging servers (106a-106d) associated with other communications services. One function of the mobile social networking platform is to integrate SMS services with Instant Messaging services. However, different services of a given type may also be integrated, e.g., different Instant Messaging services. Examples of services that may be integrated by the mobile social networking platform include, but are not limited to, MSN Messenger, AOL's AIM, Yahoo! Messenger and Google's GTalk.

The integration server (100) utilizes the user's login information to function as a proxy for the user. In particular, the integration server logs into the designated Instant Messaging accounts of the sending user and prompts delivery of the message by each of the identified services. In the illustrated example, the integration server utilizes the sending user's MSN Messenger username & password to prompt delivery of the instant message to a first recipient-user (104c) via an MSN Messenger server (106c), and utilizes the user's AOL AIM username and password to prompt delivery of the instant message to a second recipient-user (104d) via AOL server (106d). Further, the integration server relays the text message to a third recipient-user (104b) who is logged-in to the integration server. IM service login and logout procedures may be implemented with scripts or more sophisticated software. More detailed examples of service initiation and operation are provided below.

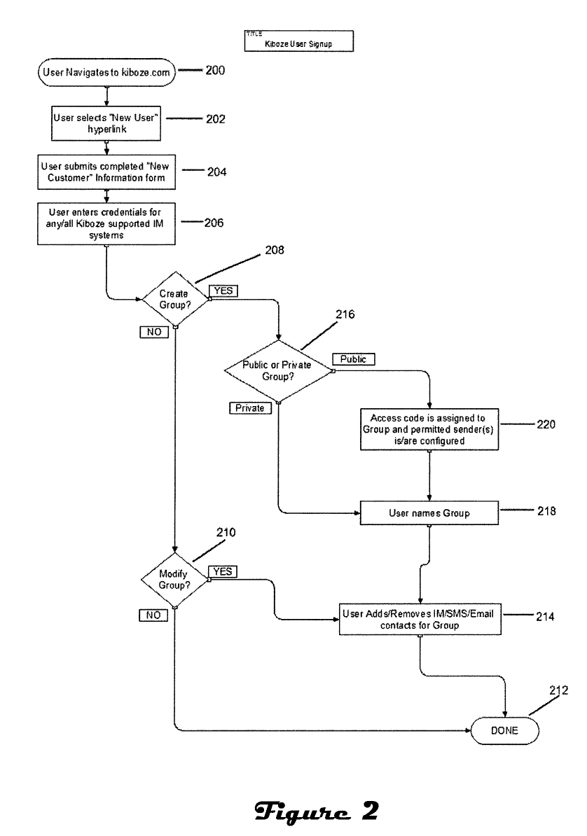

Referring now to FIGS. 1 and 2, a new user can register with the social networking platform, and an existing user can modify settings, via the internet. The new user initiates the procedure by navigating to a particular website associated with the integration server, e.g., http://www.kiboze.com, as illustrated in step (200). The user then selects a “new user” hyperlink as shown in step (202). New customer information is submitted and credentials for supported IM systems are entered as shown in steps (204) and (206), respectively. The credentials include information to enable transmission of messages via identified services, e.g., login details such as username and password of the sending user for each identified Instant Messaging service. The customer information and credentials are stored in the database, and may be encrypted for security. The user is then provided the option to create a social network group as indicated by step (208). If the user does not wish to create a group, the user is given the option to modify an existing group as indicated by step (210). If the user does not wish to modify an existing group, workflow is done as indicated by step (212). If the user does wish to modify an existing group, the user proceeds to add and remove, as desired, IM, SMS, email, and other contacts of the group, as indicated by step (214). If the user indicated a desire to create a group in step (208), the user is prompted to designate the new group as either public or private, as indicated by step (216). If the group is designated as private, the user names the group in step (218). If the group is designated public then an access code is assigned to the group and at least one permitted sender is identified, as shown in step (220), following which the user names the group. After the user names the group the user is given an opportunity to modify the contacts list of the group in step (214). Group information is stored in the database.

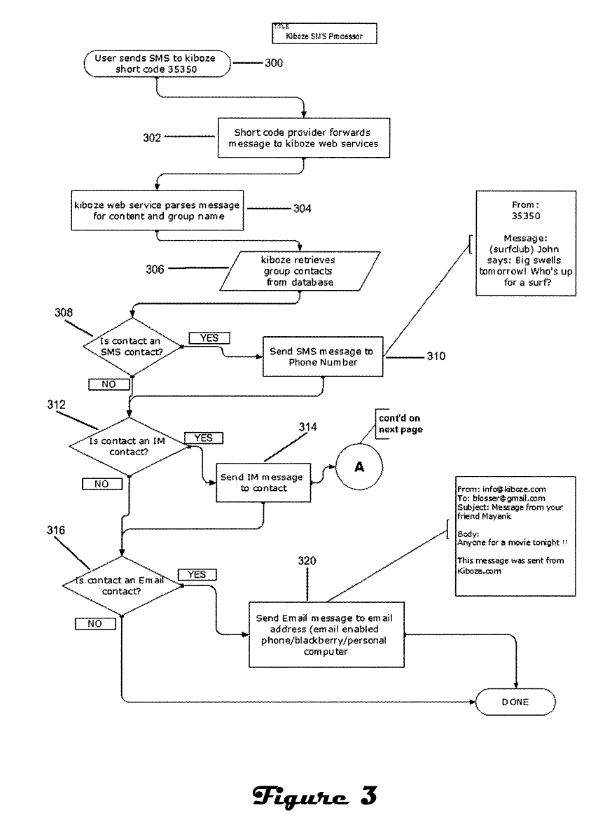

Referring to FIGS. 1, 3 and 4, operation of the social networking platform is initiated when a user provides the integration server with a message to be delivered to other users via at least one service other than the one being used by the sending user. Typically, the user will send a text message to the integration server via a server associated with the text messaging service, and the message will be delivered to a recipient via IM. The user may generate the text message on a mobile device such as a cell phone or PDA. In the illustrated example the user sends an SMS message to a short code 35350 associated with the integration server in step (300). The short code provider forwards the message to the integration server as indicated in step (302). Following receipt of the message, the integration server parses the message for content and group name as shown in step (304). The integration server then retrieves the group contacts information associated with the group name in the message as indicated in step (306). If the contact is an SMS contact, as determined in step (308), the integration server sends an SMS message to the designated phone number as shown in step (310). Whether or not the contact is an SMS contact, a determination is also made whether the contact is an IM contact, as shown in step (312). If the contact is an IM contact then an IM message is sent to the contact as indicated by step (314). Whether or not the contact is an IM contact, a determination is made whether the contact is an email contact, as shown in step (316). If the contact is an email contact then an email message is sent to the email address as shown in step (320).

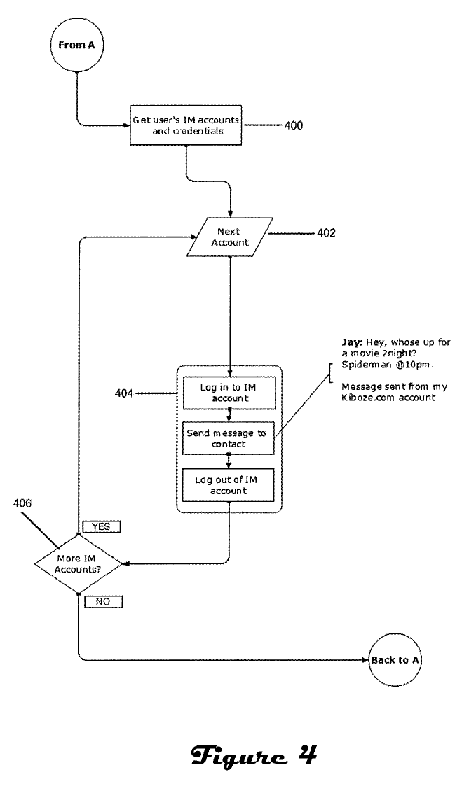

If an IM message is sent to the contact in step (314), the integration server functions as a proxy for the user as specifically shown in FIG. 4. The integration server retrieves the login information associated with each of the user's IM accounts as indicated by step (400). The server then selects one of the IM accounts as shown in step (402). For each IM account, the server logs-in to the IM account, sends a message to the contact, and logs-out of the IM account as shown in step (404). This procedure is executed until done for each IM account as determined in step (406). In view of the above description, it should be appreciated that attempts to contact a given recipient may be executed via multiple different services, i.e., both IM and other services.

Referring again to FIG. 1, depending on the preference of the user, the username and password may or may not be stored in the database (102) for subsequent use. For example, some privacy-sensitive users may prefer to provide username and password each time they use the service. Further, the order of initial delivery of the proposed message and the login information is not critical, e.g., username and password could be required beforehand to establish a subscription with the mobile social networking platform. The database may also include group address lists which associate a single, group address with multiple recipients and services by which to contact those recipients.

In an alternative embodiment the integration server provides confirmation of message transmission. In particular, once the integration server has prompted transmission of the message via one or more of the Instant Message servers, that information may be provided to the sending user via text message. Further, if the Instant Messaging server is capable of providing confirmation of receipt by the recipient, that information may be relayed back to the sending user. After prompting a given Instant Messaging server to send the Instant Message to the user-recipient, the integration server may log-off of the user's IM account.

In another alternative embodiment the integration server facilitates provision of contextual advertisements to the sending user and recipients. For example, the integration server could attempt to determine user location based on text message content, GPS, mobile application, or other means. Parsing the text message for keywords might provide additional indices for contextual advertisement. For example, the term “restaurant” or “dinner” might be used to prompt advertisement of restaurants proximate to the location of the user. If no location is determined, the default location could be the user's registered home address. The integration server may also modify or translate an incoming message for improved communication before it is delivered to the designated recipients. In one embodiment the server may modify or append text to messages based on message type, e.g., a message type known as “arrived.” In the case of a message of type “arrived,” the user simply indicates where they have arrived and the server appends that information with text that makes sense to the recipients. In particular, the user texts the term “O'leary's pub” to the server and the server appends that message and delivers “Hey, i just arrived at O'Leary's pub. Stop bye and say hi!” It should be appreciated however that the user might alternatively send a message of type “shout” with the text “whose up for a movie tonight” that would be passed via IM almost verbatim.

From the perspective of the recipient-users, the mobile social networking platform is transparent. In other words, it will appear to the recipient-user that the sending user manually logged-in to the IM account, sent a message, and then logged-off. It may therefore be desirable for the Instant Message sent to the recipient-users via the integration platform to be modified to include an indicator such as a footer which identifies the platform integration service.

In another alternative embodiment the integration server supports IM-to-SMS communications. In the case of IM-to-SMS communications, it may be desirable for the integration server to remain logged-in to the user's IM account. This could be done automatically or in response to specific user input. The duration of the session could be determined by a timer which is reset by communication activity, or any other criteria or combination of criteria. An example of IM-to-SMS is as follows. Thomas Friedman of the NYTimes has breaking news about Iraq. He wants to send an IM to the integration server to deliver that news to all subscribers of his “Iraq War” group. Prior to the below steps, Friedman has added the integration server as a buddy on his IM of choice. Friedman also has a group called “Iraq War.” Any one can join this group and be alerted whenever Friedman has any news to share about this topic. In order to deliver his news, Friedman logs onto his IM client. Friedman then selects the integration server from his buddy list. Friedman then composes the breaking news message for a particular mobile social networking platform group (Iraq War). Friedman then sends the message to integration server. The integration server receives Friedman's message and, based on the message content and the sender, the integration server determines which of Friedman's ‘groups’ to send the message to, i.e., Iraq War. The integration server then sends the message to all subscribers of the Iraq War group via IM, text and/or email. Note that in this example the message does not appear to be coming from Friedman's IM client, but rather from the mobile social networking platform IM client. In other words, Friedman sends a message to the mobile social networking platform IM client and that client sends the information on to all of the people that have selected to ‘join’ that group; one distinction from the previous embodiment being that the integration platform is utilized rather than logging in to the user's IM account.

In another alternative embodiment the server operates to reduce the number of redundant messages sent to recipients. In particular, the server (100) has the ability to communicate with other servers (106a-106d) to ‘look-up’ to see if a user is available on one communication channel and if not, check the next communication channel. This is possible because some communication services provide a feature that permits an inquiry to determine whether a user is available on a certain communication platform, i.e., text, IM or email. In a specific example, user Joe wants to send a message to his work colleagues, Stan, John and Pam. To initiate the communication Joe sends a text message to the integration server. The integration server then attempts to determine the best way to deliver the message to each individual colleague. The attempts are hierarchically arranged. For example:
Is stan available on IM? Yes/No.
   Yes . . . send message to Stan as IM.
Is John available on IM? Yes/NO.
   No . . . Is John available via text?
   Yes. Send John text
Is Pam available on IM? Yes/NO.
   No, Is she available via text? Yes/NO.
      No. Send Pam email.
         Note that the determination hierarchy performs a triage through communication platforms that are ‘real-time’ (IM), near real-time (text, email) and potentially anything else (for instance maybe even delivered via phone call or phone voicemail through a text-to-speech synthetic voice technology). The server determines “is this person available via text” by examining the status of the person with the server. By default the status is “always on,” but the user has the ability to change the status to “off,” i.e., instruct the service to NOT send messages to the user.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. A method of providing a message comprising the steps of:
receiving a message from a user via a first communication service;
identifying at least one intended recipient of the message;
logging into or having immediate access to a second communication service with user-provided information; and
prompting transmission of the message to at least one intended recipient via the second communication service.

2. The method of claim 1 wherein the first communication service is a text message service.

3. The method of claim 2 wherein the second communication service is an instant messaging service.

4. The method of claim 2 including the further step of providing the text message to the intended recipient as a text message rather than via the second communication service in response to a request from the intended recipient of the message.

5. The method of claim 1 wherein identifying at least one intended recipient includes searching for a plurality of addresses corresponding to a single group address.

6. The method of claim 1 including the further step of prompting the sending user to provide username and password for the second communication service.

7. The method of claim 1 including the further step of providing confirmation of transmission of the message to at least one intended recipient via the second communication service.

8. The method of claim 1 including the further step of providing confirmation of receipt by the intended recipient.

10. The method of claim 1 including the further step of determining approximate user location.

11. The method of claim 10 including the further step of determining approximate user location based on the message received from the user via the first communication service.

12. The method of claim 10 including the further step of providing a contextual advertisement based on the approximate user location and at least one keyword in the message.

13. A computer readable medium encoded with program code for providing a message comprising:
logic for receiving a message from a user via a first communication service;
logic for identifying at least one intended recipient of the message;
logic for logging into or having immediate access to a second communication service with user-provided information; and
logic for prompting transmission of the message to at least one intended recipient via the second communication service.

14. The computer readable medium of claim 13 wherein the first communication service is a text message service.

15. The computer readable medium of claim 14 wherein the second communication service is an instant messaging service.

16. The computer readable medium of claim 14 further including logic for providing the text message to the intended recipient as a text message rather than via the second communication service in response to a request from the intended recipient of the message.

17. The computer readable medium of claim 13 further including logic for searching for a plurality of addresses corresponding to a single group address.

18. The computer readable medium of claim 13 further including logic for prompting the sending user to provide username and password for the second communication service.

19. The computer readable medium of claim 13 further including logic for providing confirmation of transmission of the message to at least one intended recipient via the second communication service.

20. The computer readable medium of claim 13 further including logic for providing confirmation of receipt by the intended recipient.

21. The computer readable medium of claim 13 further including logic for determining approximate user location.

22. The computer readable medium of claim 21 further including logic for determining approximate user location based on the message received from the user via the first communication service.

23. The computer readable medium of claim 21 further including logic for providing a contextual advertisement based on the approximate user location and at least one keyword in the message.

24. Apparatus for providing a message comprising:
a network device in communication with a network, and including
a receiver operable to receive a message from a user via a first communication service;
a processor operable to identifying at least one intended recipient of the message; and
a transmitter operable to login to or having immediate access to a second communication service with user-provided information and prompting transmission of the message to at least one intended recipient via the second communication service.

25. The apparatus of claim 24 wherein the first communication service is a text message service.

26. The apparatus of claim 25 wherein the second communication service is an instant messaging service.

27. The apparatus of claim 25 wherein the network device is operable to provide the text message to the intended recipient as a text message rather than via the second communication service in response to a request from the intended recipient of the message.

28. The apparatus of claim 24 further including a memory having stored therein a plurality of addresses corresponding to a single group address.

29. The apparatus of claim 24 wherein the network device is operable to prompt the sending user to provide username and password for the second communication service.

30. The apparatus of claim 24 wherein the network device is operable to provide confirmation of transmission of the message to at least one intended recipient via the second communication service.

31. The apparatus of claim 24 wherein the network device is operable to provide confirmation of receipt by the intended recipient.

32. The apparatus of claim 24 wherein the network device is operable to determine approximate user location.

33. The apparatus of claim 32 wherein the network device is operable to determine approximate user location based on the message received from the user via the first communication service.

34. The apparatus of claim 32 wherein the network device is operable to provide a contextual advertisement based on the approximate user location and at least one keyword in the message.
